(19) United States
(12) Patent Application Publication
(10) Pub. No.: US 2009/0109026 A1
(43) Pub. Date: Apr. 30, 2009

(54) Multiple Electric Fence Energisers On a Data Network

(76) Inventor: Paul Thompson, Narangba (AU)

Correspondence Address: COOK ALEX LTD, SUITE 2850, 200 WEST ADAMS STREET, CHICAGO, IL, 60606, US

(21) Appl. No.: 12/259,067

(22) Filed: Oct. 27, 2008

Related U.S. Application Data
(60) Provisional application No. 60/982,941, filed on Oct. 26, 2007.

(51) Int. Cl. G08B 13/26

(52) U.S. Cl. 340/564

(57) ABSTRACT

An electric fence energizer includes a pulse generator for generating pulses to be applied to a fence; a clock which determines the time at which the pulses are generated; and an adjustment circuit to adjust the clock for error in time or drift in time. The energizer may include a plurality of pulse generators which provides a plurality of pulses to be applied to a fence, and the pulse generators may be grouped into a network. The energizer may further include a data processor; and a quartz crystal locked oscillator. A first of the plurality of pulse generators acts as a master and periodically sends time messages to the remaining pulse generators to keep the remaining pulse generators in synchronization with the first pulse generator.

### CROSS-REFERENCE TO RELATED APPLICATION

This non-provisional patent application claims a right of priority to provisional patent application Ser. No. 60/982,941, filed on Oct. 26, 2007, which is incorporated in its entirety herein by reference.

### FIELD OF THE INVENTION

The present invention relates to electric fence energizers and in particular to coordination of groups of electric fence energizers connected together using data networks. Although the invention will be described particular reference to energizers that are used for security fencing applications, it will be appreciated that the invention may be deployed with energizers that are used in other fencing applications such as agricultural fencing.

### BACKGROUND OF THE INVENTION

Electric fences are often used for security purposes to restrict unauthorised entry to certain areas such as industrial premises. They are also used for containment in detention centres.

Electric fences normally include a number of posts from which numerous non-insulated wire conductors are strung such that the conductors are insulated from the posts and therefore the ground. The conductors are coupled to an energizer that periodically outputs a high voltage pulse to energize the conductors so that intruders will receive a small electric shock if they contact the energized conductors. While the voltage is very high, up to 10,000 Volts peak, the time of the pulse is very short in order to be safe typically in the order of 100 microseconds.

The intruder receives a shock by completing the circuit from the energizer, via the live wires to ground and back to the energizer ground terminal. The spacing and height of the wires is such that it is difficult to gain access to the protected area without contacting the wires. The live wires are often interleaved with grounded wires so as to make a circuit even if the intruder attempts to insulate him or herself from the ground but touches more than one wire. If the wires are cut or shorted to ground a monitoring circuit connected to the electrical “end” of the live wires, detects the change in voltage and can sound an alarm or trigger a call to a guard centre. This monitoring is typically achieved by measuring the peak voltage. If the peak voltage falls below a predetermined threshold the fence an alarm is generated.

The magnitude and frequency of the electric pulses are restricted by safety standards such as IEC60335.2.76. These standards also state that conductors connected to two independently timed energizers must be kept apart by a minimum distance so that a person may not touch the live wires from two different energizers at once and thereby receive a shock of greater magnitude or higher frequency than is safe.

In security applications it is desirable to have independently powered sections of the fence, called zones, so that a load on one zone doesn't affect another leaving it ineffective as a barrier and also to allow for more targeted response to alarms generated from smaller parts of the enclosure. It is also desirable that individual zones be able to be turned on or off independently and therefore that they be powered from multiple energizers.

It is possible to co-ordinate the pulses of several energizers in such a way that the pulses are simultaneous or so as to lower the frequency of the individual units so that the frequency when combined is less then the limits imposed. These are known as dependently timed energizers.

Co-ordination has been achieved using serial data communications on various direct busses like RS232 and by direct connection of high voltage lines from one energizer to a special input on the next. These methods rely upon the slave instantaneously receiving the sync message or pulse with either no or at most a small and fixed time delay. The master or group coordinator sends the message to trigger a pulse and slaves see it and fire their pulse generators.

This method relies on a direct connection between the master or group coordinator and the slaves. If the connection fails the slaves will probably shut down. Prior art energizer pulse timing circuits are not accurate enough for the slaves to continue once the signal from the master is lost. Since it is required for the timing of each pulse the connection between the master and slaves could not be routed over a packet switched network like a LAN or even via radio modems due to the time delays or “latency” involved in these networks.

Many industrial facilities are now using facility wide communications system networks. LAN's or WANs with TCP/IP over copper, fibre optic or radio. It is desirable to send all data on these available systems, rather than going to the expense of adding more cable. In some installations the preferable method of implementing the data connection is via radio modem. Advances in modems, especially short haul low power unlicensed systems means that this can be the most cost effective way of linking energizers in the field.

It is an object of the present invention to provide an electric fence electric fence energizer with a coordination method that overcomes, or at least ameliorates, one or more of the deficiencies of the prior art electric fence energizers mentioned above, or that provides the consumer with a useful or commercial choice.

### SUMMARY OF THE INVENTION

According to a first aspect of the present invention there is provided a security electric fence energizer which includes an accurate clock which determines the time at which the pulse is generated. The energizer also includes a means of this clock being adjusted to correct for error or drift. When multiple units made according to this invention are grouped into a network the output pulses of all the units will be either simultaneous or at least within the time frame acceptable under safety standards, that is within approximately 1 milli second.

In the preferred embodiment of the invention the energizer includes a microcontroller with a quartz crystal locked oscillator. The embedded code is written such that the pulse timer, or clock, is as stable as possible. No tasks or interrupts are allowed to take higher priority over the timer. With this type of clock two energizers started at the same time will remain in sync, to within the required time frame, for many minutes even in the absence of clock adjustment. The clock is also written so that the time can be read at any point in the cycle without error. The maximum drift error of the clock can be measured and quantified as a known maximum time error per cycle, or inversely the maximum number of cycles the unit will remain within ‘safe’ synchronization tolerances. The clock on all units cycles though 0 to the pulse time (typically 1.2000 Seconds) and back to 0 continuously, while power is on, even if the unit is in standby.

Alternately the clock may be a real time clock where the pulse is generated at precise intervals from a predetermined datum.

In order to keep the clocks of members of a group aligned with each other each unit is able to request the time from other units. If the unit also records the time between the request for time and the reply. The data packet delay between the two units can be measured and therefore used in the calculation to adjust the clock. In this way the group may maintain the same time and therefore remain in sync. Such methods have been used to synchronise computer clocks for many years and include Marzullo's algorithm as used in the TCP/IP Network Time Protocol. To the authors knowledge these techniques have never been applied to electric fence energizers.

According to a second aspect of the present invention there is provided a security electric fence energizer which includes an accurate clock which determines the time at which the pulse is generated. The energizer also includes a means of this clock being adjusted to that of a timer server.

One of the group, which may be called the group master, acts as the time server for the group. The master periodically sends a time message to other units, containing the masters time, a slave can compare it to its own clock and adjust it if required to remove drift errors. By pinging the master a slave can determine the path latency and remove this from the calculation to make adjustment. The group master roll can be arbitrated between the group members such that if the master is lost another takes its place. Due to the inherent accuracy of the clocks the adjustment need only happen often enough to keep the clocks sufficiently well aligned, much less often then the pulse interval.

Alternatively a slave can initiate the communications with a ping and the master replies with a packet which includes the current time according to the master. In this way the calculation of the path delay and the collection of the masters time are coincident and not effected by variable path latency.

This assumes that the time from the master to the slave is half of the round trip time. If care is taken to match packet sizes then this will usually be the case.

A further refinement of this method is to filter the error gained by each successive ping of the master and only apply a correction based on the filtered error.

According to a third aspect of the present invention there is provided a security electric fence energizer which includes an accurate clock which determines the time at which the pulse is generated. The energizer also includes a means of this clock being adjusted to that of a standard network time protocol timer server using the UDP transport layer built into the TCP/IP protocol. All of the energizers then fire at precise intervals from a predetermined datum.

### BRIEF DESCRIPTION OF THE DRAWINGS

In order that this invention may be more readily understood and put into practical effect, reference will now be made to the accompanying drawings which illustrate typical preferred embodiments of the invention and wherein:

FIG. 1 is a block diagram of a group of energizers according to the present invention.

FIG. 2 is a waveform diagram of the pulses from the outputs of a group of energizer according to this invention.

FIG. 3 shows an enclosure with a security fence powered from a group of four energizers where at each corner the live wires come into close proximity.

FIG. 4 shows a time line for the messages between two energizers.

### DESCRIPTION OF THE PREFERRED EMBODIMENTS

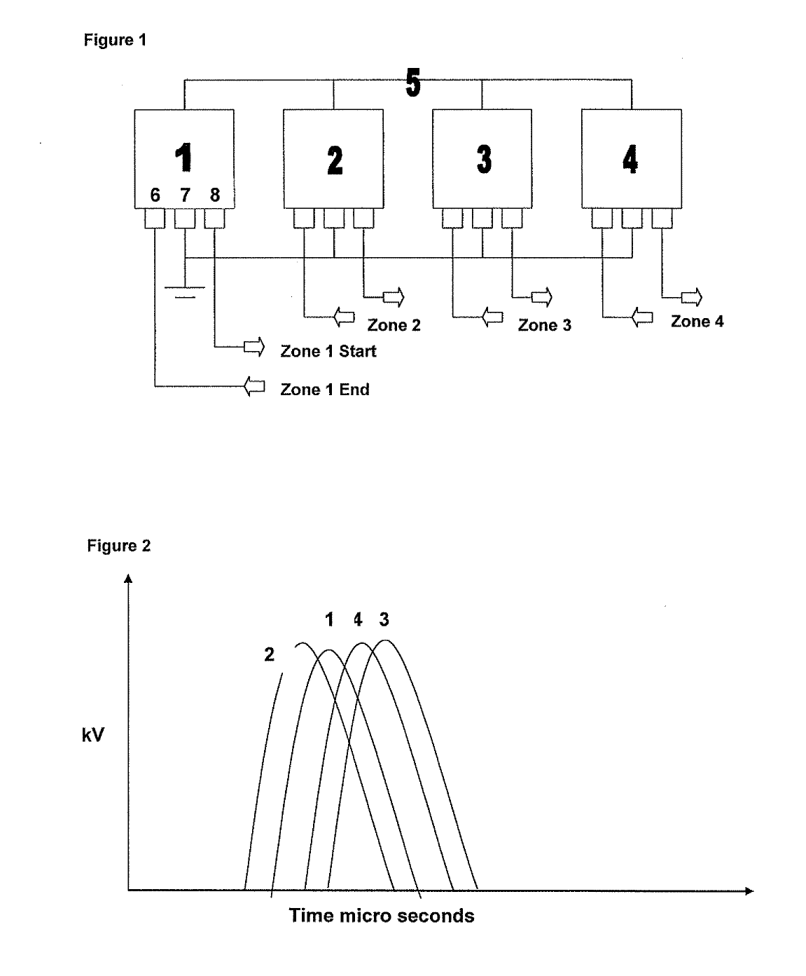

With reference to FIG. 1 there is depicted a block diagram of an electric fence system made of multiple linked energizers. 1 to 4 are energizers within the group linked by the communication bus 5. Unit 1 has terminals 6 for zone return voltage 7 for earth and 8 for zone output. Message sent back and forward along the bus 5 incur delays.

FIG. 2 is a waveform diagram of the pulses from the outputs of a group of energizer according to this invention. The pulses are simultaneous with a small random time error.

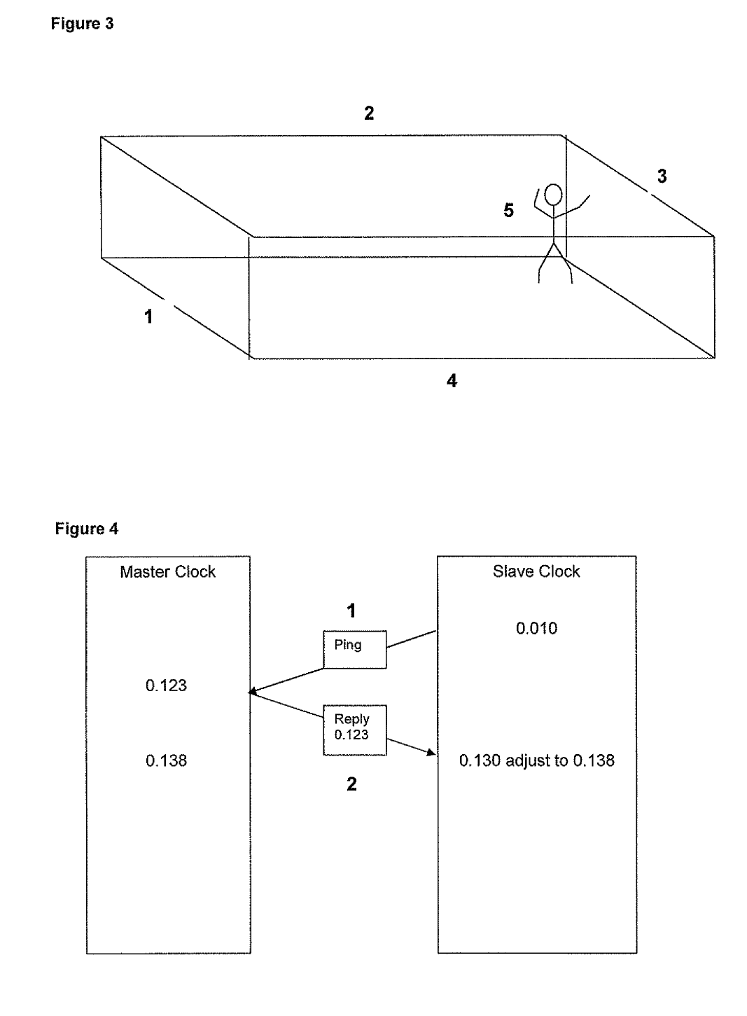

FIG. 3 shows an enclosure with a security fence powered from a group of four energizers where at each corner the live wires come into close proximity. If an individual 5 was to touch the fence with one hand on side 2 and one on side 3 due to the pulses being almost coincident the individual will not receive a dangerous shock.

FIG. 4 shows a time line for the messages between two energizers. At 1 a slave sends a ping packet to the master, when the ping was sent the slaves clock was at 0.100 (seconds). The ping arrives and the master when the masters clock is at 0.123. The master sends a reply 2 to the slave and includes the time (0.123) in the reply. The slave receives the reply when it's clock reads 0.130. It knows that the entire round trip took 0.030 seconds (30 milli seconds). It therefore can assume that the masters time is currently 0.123+0.030/2=0.138. The difference between the masters clock and its own is 8 mS. It can therefore adjust its clock to the correct time of 0.138.

While particular embodiments of the invention have been shown and described, it will be obvious to those skilled in the art that changes and modifications may be made therein without departing from the invention in its broader aspects.

1. An electric fence energizer comprising:
a means for generating pulses to be applied to a fence;
a clock which determines the time at which the pulses are generated; and
means to adjust the clock for error in time or drift in time.

2. The electric fence energizer in accordance with claim 1 further comprising:
a plurality of means for generating pulses which provides a plurality of pulses to be applied to a fence.

3. The electric fence energizer in accordance with claim 1 wherein the plurality of means for generating pulses is grouped into a network.

4. The electric fence energizer in accordance with claim 2 further comprising:
a data processor; and
a quartz crystal locked oscillator.

5. The electric fence energizer in accordance with claim 2 wherein one of the plurality of means for generating pulses acts as a master and periodically sends time messages to the remaining plurality of means for generating pulses.
